(19) United States
(12) Patent Application Publication
(10) Pub. No.: US 2018/0027784 A1
(43) Pub. Date: Feb. 1, 2018

(54) RIGGING CONFIGURATION FOR A COMMERCIAL FISHING TRAWL

(71) Applicant: GX Technology Canada Ltd., Calgary (CA)

(72) Inventor: Daniel George Martin, Woodstock (CA)

(73) Assignee: GX Technology Canada Ltd., Calgary, AB (CA)

(21) Appl. No.: 15/550,552

(22) PCT Filed: Feb. 11, 2016
(86) PCT No.: PCT/CA2016/000034

§ 371 Date: Aug. 11, 2017

Related U.S. Application Data
(60) Provisional application No. 62/114,771, filed on Feb. 11, 2015.

(51) Int. Cl. A01K 73/045; A01K 73/05

(52) U.S. Cl. CPC A01K 73/045; A01K 73/05

(57) ABSTRACT

A commercial fishing trawl has a net and a mouth opening defined by a head line, a foot line, and side lines. The mouth opening is spread by a plurality of foil segments threaded on one or more of the head line, foot line, or side lines. Foil segments may also be threaded on tag lines or foil lines attached about the mouth opening to spread and maintain the mouth opening as the trawl is towed through the water, behind a tow vessel.

### FIELD OF THE INVENTION

The present invention relates to fishing trawls and, in particular, to devices for spreading the mouth opening of the fishing trawl.

### BACKGROUND

Commercial fishing trawls are designed, inter alia, to maximize the cross-sectional area of the mouth opening of the trawl. This is typically achieved through application of floats across the span of the head line, weights across the span of the foot line, and trawl doors to port and starboard sides to spread the mouth opening. The trawl is then connected to the tow vessel by two warp cables, one connected to each trawl door.

A conventional pelagic trawl with a mouth perimeter of 400 meters typically requires two conventional trawl doors of about 15 square meters deployed on either side of the trawl, which create drag. The cross sections of typical floats and weights used to spread the mouth opening of the trawl vertically also create drag. Traditional floats and weights apply constant vertical forces, independent of tow speed. Consequently, the mouth opening tends to collapse with increasing tow speeds.

Accordingly, there is a need to provide a fishing trawl which maximizes and maintains the cross-sectional area of the mouth opening of the trawl, while decreasing drag, and consequently, the towing force required to tow the trawl through the water behind the tow vessel.

### SUMMARY OF THE INVENTION

A fishing trawl, according to the present invention, has a net with a mouth opening defined by a head line, a foot line, and side lines. A plurality of longitudinally alignable foil segments each having a foil cross-section, a leading edge, a trailing edge, the leading edge and trailing edge defining a chord, a span, and an internal conduit extending along the span positioned rearward of the leading edge of the foil segment. One of the head line, foot line, or side lines pass through the internal conduits of the plurality of foil segments.

In another embodiment, a second head line, a second foot line, and second side lines are provided. The foil segments each further comprise a second internal conduit extending along the span positioned forward of the trailing edge of the foil segment and one of the second head line, second foot line, or second side lines pass through the second internal conduits of the plurality of foil segments.

In another embodiment, each foil segment has opposing sides which converge rearwardly from the leading edge to give each foil segment a trapezoidal-like shape with a divergent angle between the sides of adjacent foil segments.

In another embodiment, an adjustment mechanism varies the length of the second head line, second foot line, or one of the second side lines passing through the second internal conduits of the plurality of foil segments.

In another embodiment, the head line, foot line, and side lines are continuous with one another.

### BRIEF DESCRIPTION OF THE DRAWINGS

In order that the invention may be more clearly understood, embodiments thereof will now be described in detail by way of example, with reference to the accompanying schematic drawings, in which:

FIG. 1a is front view of a conventional fishing trawl.

FIG. 1b is a top view of a conventional fishing trawl.

FIG. 2 is a front view of one embodiment of a fishing trawl, according to the present invention.

FIG. 3a is a cross-sectional view of a foil segment.

FIG. 3b is a cross-sectional view of a foil segment with an internal conduit positioned to one side of the chord.

FIG. 4 is a front view of another embodiment of a fishing trawl, according to the present invention.

FIG. 5 is a front view of another embodiment of a fishing trawl, according to the present invention.

FIG. 6 is a top view of another embodiment of a fishing trawl, according to the present invention.

FIG. 7a is a side view of a plurality of foil segments.

FIG. 7b is a side view of a plurality of foil segments, according to one aspect of the present invention.

FIG. 8 is a front view of a plurality of foil segments having a curved profile.

FIG. 9 is a view of a plurality of foil segments with a bridle.

FIG. 10 is a front view of a plurality of foil segments, with a bridle and an angled profile.

FIG. 11 is a front view of a plurality of foil segments, with a bridle and a curved profile.

FIG. 12 is a schematic side view of an adjuster mechanism connected to a plurality of foil segments.

### DESCRIPTION OF THE INVENTION

A fishing trawl, according to the present invention, has a mouth opening that is spread by a plurality of foil segments. The foil segments may supplement or replace any or all of the head line floats, foot line weights, or trawl doors, which are typically used to spread the mouth opening of a trawl as it is towed through the water behind a tow vessel.

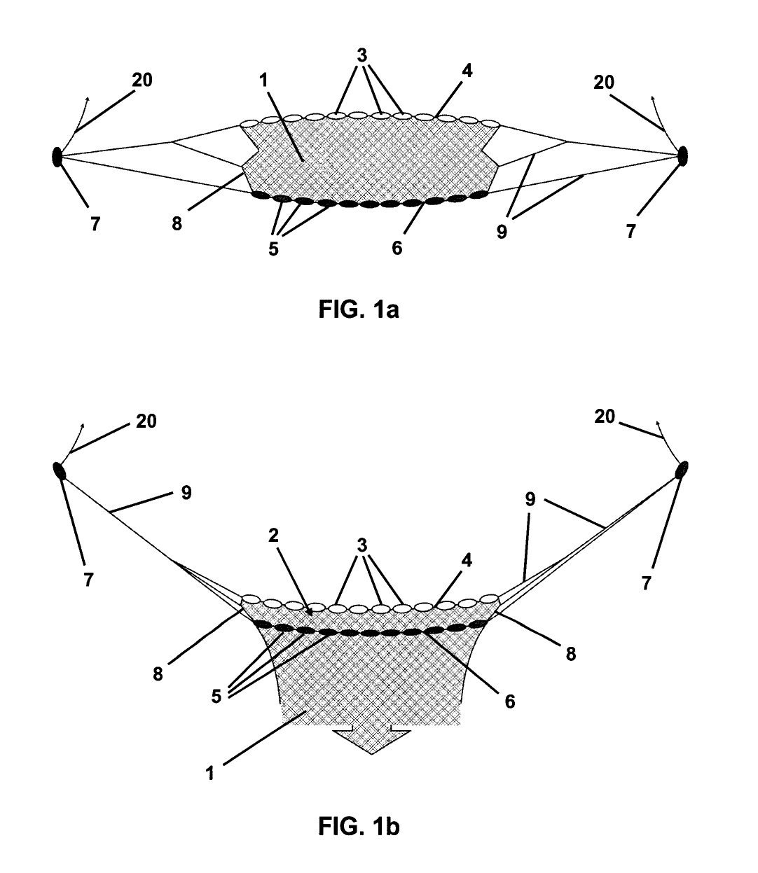

As shown in FIGS. 1A and 1B, a conventional fishing trawl has a net 1 with a mouth opening 2 spread apart by floats 3 attached along a head line 4, weights 5 attached along a foot line 6, and trawl doors 7 at the side lines 8. Generally, the floats 3 and weights 5 have a cross-section, which results in a high drag coefficient. The trawl doors 7 are generally spaced apart from the side lines 8 and attached thereto by bridle legs 9.

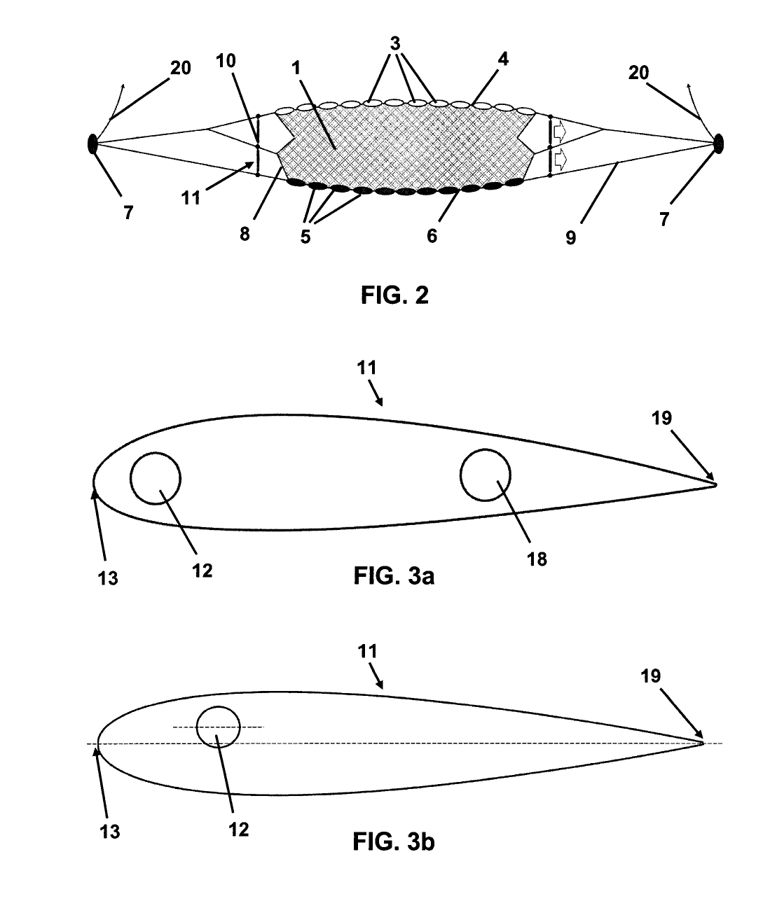

In one embodiment, as shown in FIG. 2, vertical tag lines 10 may be installed between the bridle legs 9 of a conventional fishing trawl and foil segments 11 may be attached on or to the tag lines 10 to provide lateral force for spreading the mouth opening 2 of the net 1. Each foil segment 11 has a span, a chord, a foil cross-section, which may be a standard hydrofoil cross-section, and a forward internal conduit 12 along the span and rearward of the leading edge 13, as shown in FIG. 3a, by way of example. Different foil cross-sections may be used, such as NACA, Eppler, Gottingen, or any other custom foil cross-section suitable for the desired application. The tag lines 10 are threaded through the forward internal conduit 12 of the foil segments 11. Preferably, the foil segments 11 are cambered, or otherwise asymmetric, so that the foil assumes a non-zero equilibrium angle of attack as it is towed through the water and thereby generates lift. Alternatively, a symmetric foil cross-section may be used with a forward internal conduit 12 to either side of the chord line, as shown in FIG. 3b. In this embodiment, the foil segments 11 provide lateral force to supplement the spreading force produced by the trawl doors 7.

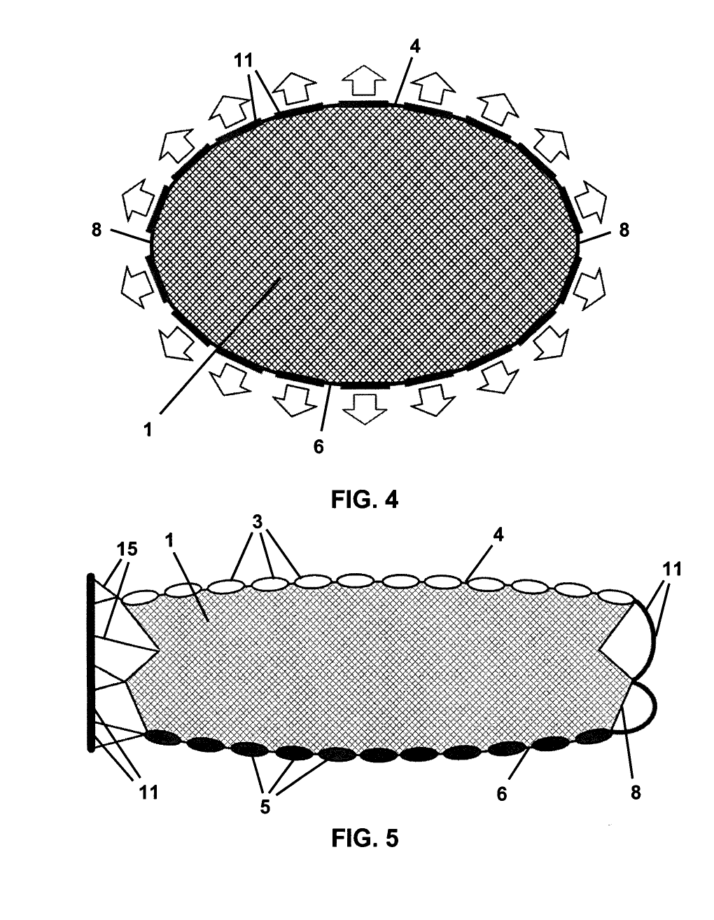

In another embodiment, as shown in FIG. 4, foil segments 11 are threaded on the head line 4, by passing the head line 4 through the forward internal conduits 12 of each foil segment 11, to generate lift upwardly and thereby replace the floats 3 used on conventional trawls. Similarly, foil segments are threaded on the foot line 6 and side lines 8 to generate lift downwardly and laterally and thereby replace the weights 5 and trawl doors 7. In this embodiment, as illustrated in FIG. 4, the head line 4, foot line 6, and side lines 8 are schematically shown as a single continuous line, defining the mouth opening 2. In other embodiments, the foil segments 11 may be threaded on separate head lines 4, foot lines 6, and side lines 8. As shown in FIG. 4, the mouth opening 2 is elliptical, but the foil segments 11 and lines 4, 6, and 8 may be configured to generate lift forces appropriate for a mouth opening 2 of any desired shape. In this embodiment, the foil segments 11 generate all the spreading forces required to spread the mouth opening 2 of the net 1 as the trawl is towed through the water.

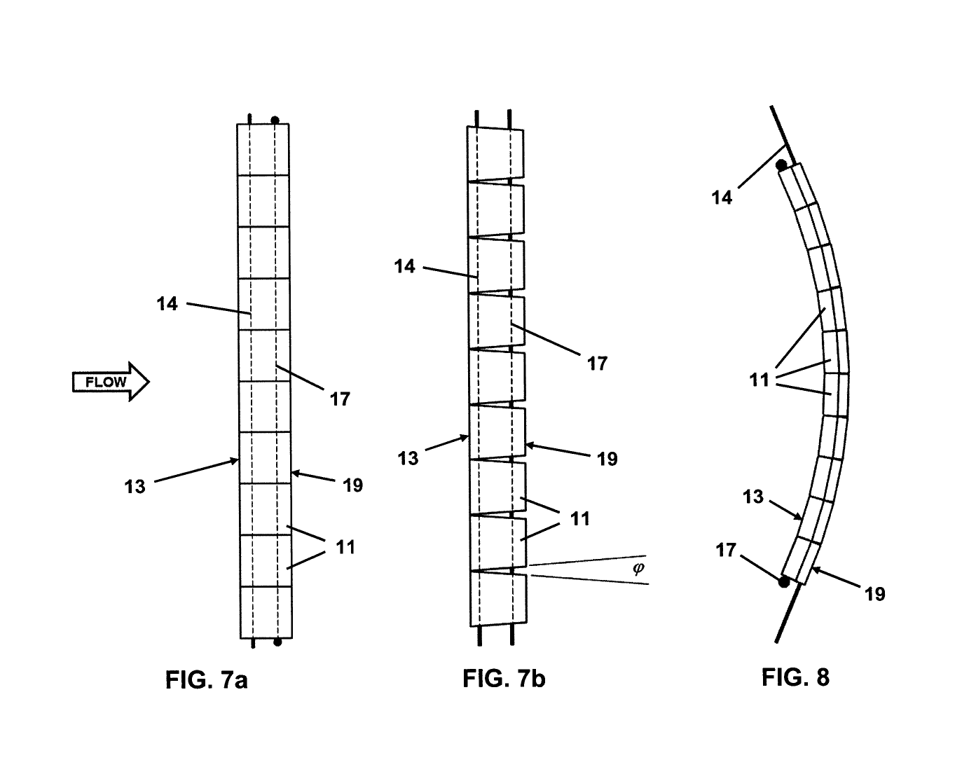

In another embodiment, as shown in FIGS. 5 and 7a, foil segments 11 are threaded on a foil line 14, which is attached to the side lines 8 to provide lateral forces to spread the mouth opening 2 of the net 1. The foil line 14 is independent of the head line 4, foot line 6, and side lines 8, and is threaded through the forward internal conduits 12 of the foil segments 11 and attached at both ends to one of the side lines 8. The foil line 14 may be a cable, rope, wire, chain, or other type of rigging line that passes through the forward internal conduits 12 of each of the foil segments 11 and may be secured at either end of the foil segments 11, for example by knotting the cable to prevent egress, as shown in FIG. 7a. Alternatively, the foil line 14 may be attached to one of the side lines 8 by way of bridle lines 15.

The foil segments may also have an aft internal conduit 18 along the span and forward of the trailing edge 19, as shown in FIG. 3a. When both ends of the foil line 14 are attached to one of the side lines 15, a second foil line 17 may be threaded through the aft internal conduits 18 of each foil segment 11, as shown in FIGS. 7a, 7b, and 8. In this configuration, the foil segments 11 are longitudinally aligned to form a wing section. The foil lines 14 and 17 permit steering of the foil segments 11 as described in PCT/CA2012/000996 entitled “Steerable Fairing String”. Alternatively, the second foil line 17 may be omitted and the foil segments 11 strung along only the foil line 14. In embodiments where the second foil line 17 is omitted asymmetric foils are used whereby the foil segments 11 assume a non-zero equilibrium angle of attack and thereby generate lift in the desired direction.

Alternatively, the foil line 14 may be attached to one of the side lines 8 by way of bridle lines 15, as shown in FIG. 5. The lengths of the bridle lines 15 are selected to maintain a vertical and linear, or longitudinally aligned, stack 16 of foil segments 11 when the trawl is being towed through the water. Preferably, the bridle lines 15 are attached at one end to the foil line 14 between each foil segment 11 in the stack 16. At the other end, the bridle lines 15 are attached to spaced apart locations on one of the side lines 8. This configuration of a stack 16 of foil segments 11, attached to one of the side lines 8 by way of bridle lines 15, is referred to herein as a segmented-foil. Similarly, a second foil line 17 may be threaded through the aft internal conduits 18 of each foil segment 11 to provide additional structural support to the stack 16 and to provide steerability, as will be described hereafter.

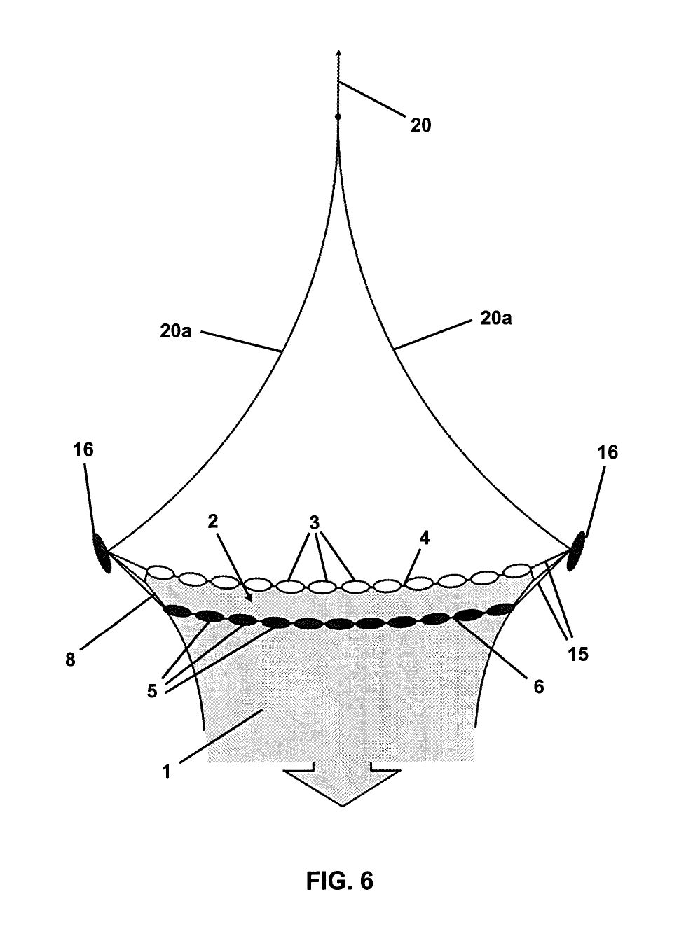

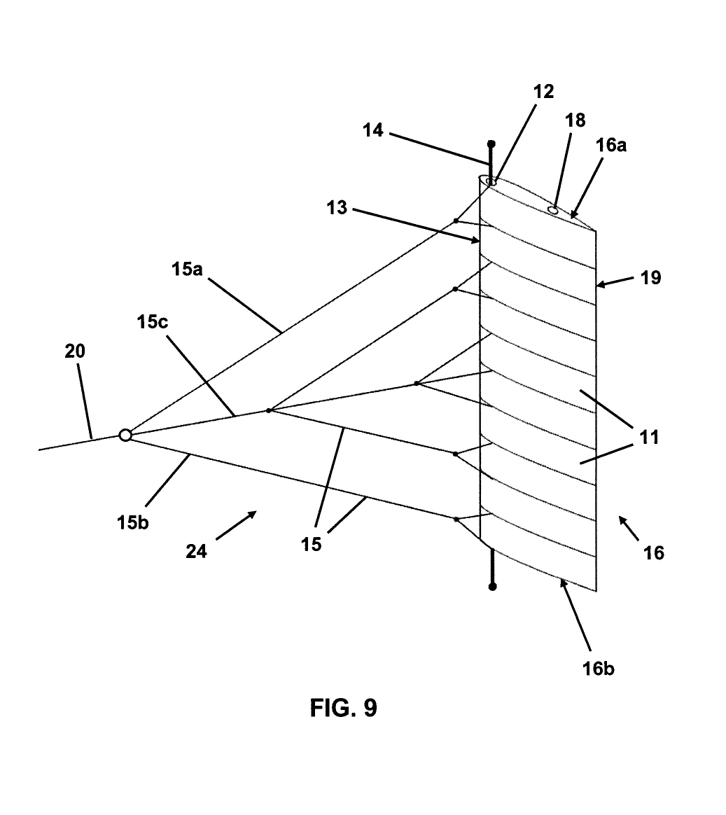

Alternatively, as shown in FIG. 6, the conventional trawl doors may be replaced by a segmented-foil attached to the warp line 20 by way of a generally triangular-like bridle 21, as described in PCT/CA2015/000593 entitled “Segmented-Foil Divertor”. The bridle 21 is attached at one end to the warp line 20 and at the other end to the stack 16 of foil segments 11, as shown in FIG. 9. Alternatively, rather than attaching the bridle 21 to the warp line 20, it may be attached at any desired location about the mouth opening 2 of the trawl.

The bridle 21 has an apex, sides, and a base, defining its triangular-like shape. The apex is defined by a connection point between the bridle 21 and the warp line 20. The sides are defined by a number of bridle lines 15. A first bridle line 15a is attached between the connection point and one end, the top end 16a, of the stack 16 and a second bridle line 15b is attached between the connection point and the other end, the bottom end 16b, of the stack 16. One or more intermediate bridle lines 15c are also attached between the connection point and the stack 16 between the opposing ends of the stack 16. Optionally, branching bridle lines 15 are used to complete the bridle rigging, as shown in FIG. 9. Preferably, the bridle lines 15 attach to the plurality of foil segments 11 by way of attachment to the foil line 14 at each free end of the foil line 14 extending outwardly from each end of the stack 16 and in between each foil segment 11. Optionally, the free ends of the foil line 14 may be continuous with the bridle lines 15. Alternatively, the bridle lines 15 may be attached directly to one or more of the plurality of foil segments 11.

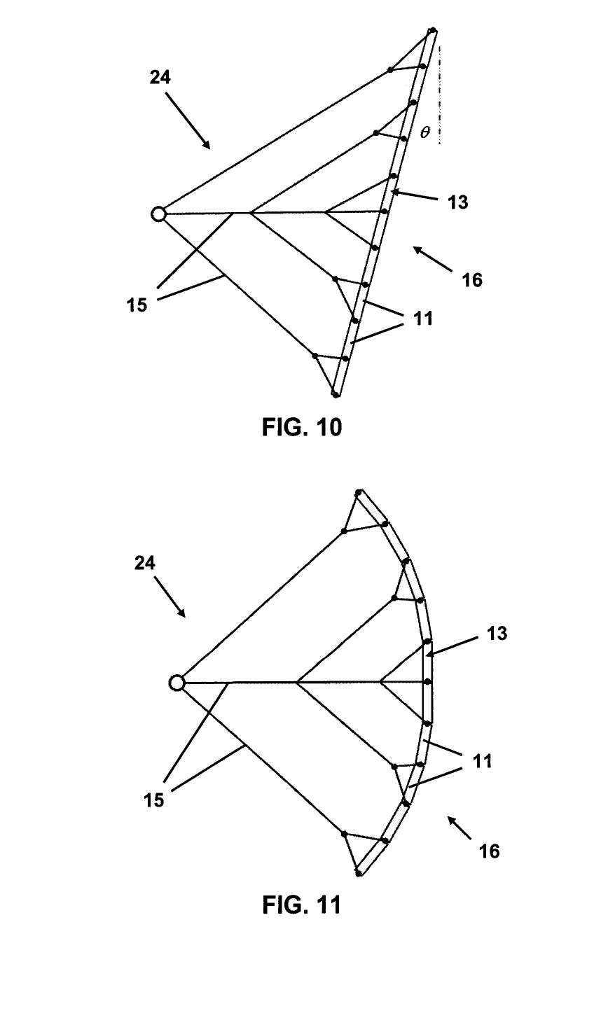

The length of the bridle lines 15 are selected to maintain a vertical and linear, or longitudinally aligned, stack 16 of foil segments 11 when the segmented-foil is being towed through the water, as shown in FIG. 9. In this embodiment, the sides of the bridle 21 are of equal length. Alternatively, the relative length of the bridle lines 15 on the top half of the stack 16 may be selected to be longer than those on the bottom half of the stack 16 to maintain an angled stack 16, as shown by the angle θ in FIG. 10. In this embodiment, the sides of the bridle 21 are of unequal length. The positive or negative angle θ by which the stack 16 is offset from the vertical, as shown in FIG. 10, may be selected to produce a force with a component in the vertical direction. This enables the segmented-foil to be used both as a divertor to position the towed equipment laterally to one side or the other of the towing vessel, and also as a depressor to position the towed equipment at a desired depth. Alternatively, the length of the bridle lines 15 may be selected to maintain a curved stack 16, as shown in FIGS. 8 and 11. Bridle line lengths are thus selected to impart the desired stack shape to the segmented-foil.

The foil lines 14 and 17, threaded through the forward and aft internal conduits 12 and 18 of the foil segments 11, will assume a curved profile, as shown in FIGS. 5 and 8, as they are towed through the water. The length of either of the foil lines 14 and 17 may be selectively varied to control the angle of attack of the foil segments 11, thereby producing more or less lift.

Preferably, as shown in FIG. 7b, the sides of the foil segments 11 converge rearwardly, such that the span decreases from the leading edge 13 to the trailing edge 19 to provide each foil segment 11 with a trapezoidal shape and a wedged gap, or divergent angle φ, between foil segments 11. Preferably, the trapezoidal foil segments 11 are used in combination with bridle lines 15 configured to maintain a curved profile, as shown in FIG. 11. In this configuration, the length of the second foil line 17 passing through the aft internal conduits 18 of the stack 16 may be selectively shortened to draw the rear edges of the foil segments 11 together and close the divergent angle φ, shown in FIG. 7b. As the rear edges of the foil segments 1 are drawn together, each foil segment 11 rotates about the foil line 14, changing its angle of attack as it is towed through the water, as shown in FIG. 8. This occurs because the combined length of the leading edges 13 of the foil segments 11 is longer than the combined length of the trailing edges 19.

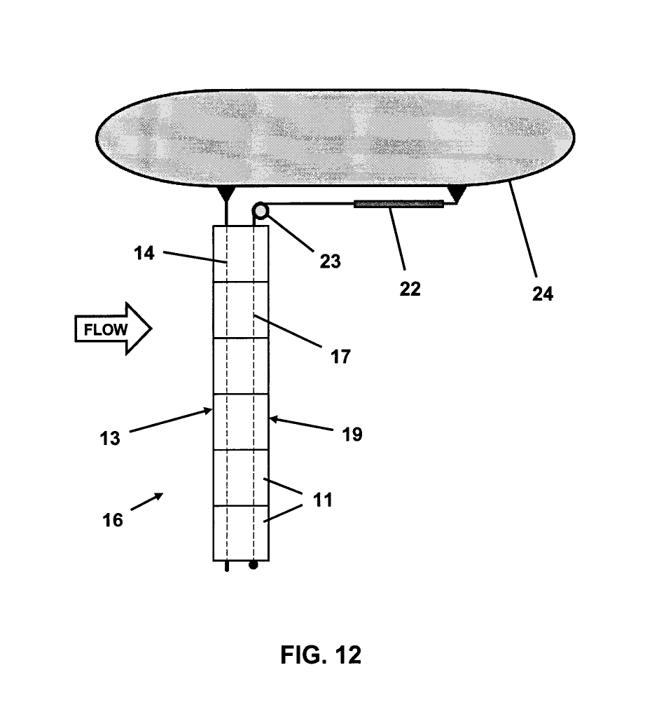

An adjuster mechanism, as shown in FIG. 12, may be connected to the second foil line 17 to operationally and selectively shorten or lengthen the second foil line 17 to adjust the angle of attack of the foil segments 11 in the segmented-foil. The adjuster mechanisms may include a turnbuckle 22 and pulley 23, installed on the foil line 17 between the foil segments 11 and a pod 24, which houses the communication and electronic components of the adjuster mechanism. Alternatively, a ratchet winch may be used. For automated adjustment of the foil line 17, an electric solenoid may be used. Alternatively, a hydraulically or pneumatically controlled ram and piston, an electric winch, or a motor driving a rack and pinion may be used.

Adjusting the angle of attack results in more or less force from each foil segment 11. Maximum force is achieved when the divergent angle φ is completely closed. Accordingly, the overall amount of force produced by the segmented-foil may be controlled selectively by the adjuster mechanism as the segmented-foil is towed through the water. This may be controlled automatically or manually by an operator on the towing vessel, by known methods of remote controlling towed equipment. Alternatively, the length of the second foil line 17 may be set at the time of deployment.

Although the embodiments shown in FIG. 5 are described with reference to the side lines 8, foil segments 11 threaded on a foil line 14 or a segmented-foil may also be attached to the head line 4 or the foot line 6 to provide lift upwardly or downwardly. In some embodiments, the trawl is thereby provided with steerability in the vertical direction. In addition, the embodiment shown in FIG. 4 may include two headlines 4, two foot lines 6, and two pairs of side lines 8 passing through the forward and aft internal conduits 12 and 18 of each foil segment 11. The trawl is thereby provided with steerability as described above, by adjusting the relative lengths of the two head lines 4, two foot lines 6, or either of the two pairs of side lines 8. Preferably, a separate adjuster mechanism is engaged with each of the two head lines 4, two foot lines 6, and the two pairs of side lines 8. For example, four such adjuster mechanisms permit steerability of the trawl vertically and laterally through lengthening or shortening of the head lines 4, foot lines 6, or side lines 8.

In a conventional trawl configuration, two one-inch (1″) diameter steel cables are used for warp lines 20, which are deployed from port and starboard reels on the deck of the tow vessel and connected to the port and starboard trawl doors 7. As shown in FIG. 6, the trawl may be towed by a single warp line 20 connected to the tow vessel, rather than the conventional trawl configuration, which is towed by two warp lines 20, as shown in FIG. 1B. The warp line 20 is split into two secondary warp lines 20a near the end attached to the trawl. Each secondary warp line 20a attaches to a segmented-foil on either side of the mouth opening 2. Alternatively, the secondary warp lines 20a may attach directly to the side lines 8 or another point on the rigging about the mouth opening 2 of the net 1. The use of a single warp line 20, rather than two warp lines 20, reduces drag and thereby reduces the force required to spread the mouth opening 2 of the net 1 and the back deck handling equipment required to deploy and retrieve a trawl with two warp lines 20.

In some embodiments, which include steerability, remote control may be provided by way of an adjuster mechanism which communicates with onboard equipment on the tow vessel and controls the relative lengths of the foil lines 14 and 17, or other lines, passing through the forward and aft internal conduits 12 and 18 of the foil segments 11. Communication between the vessel and the adjuster mechanism may be provided by known means already in common practice in the commercial fishing industry, for example, Ultra-Short Base Line (USBL) communication with acoustic modems.

The scope of the following claims should not be limited by the preferred embodiments set forth herein, but should be given the broadest interpretation consistent with the specification as a whole.

What is claimed is:

1. A fishing trawl, comprising:
a net having a mouth opening defined by a head line, a foot line, and side lines; and
a plurality of longitudinally alignable foil segments each having a foil cross-section, a leading edge, a trailing edge, the leading edge and trailing edge defining a chord, a span, and an internal conduit extending along the span positioned rearward of the leading edge of the foil segment;
wherein one of the head line, foot line, or side lines pass through the internal conduits of the plurality of foil segments.

2. The fishing trawl of claim 1, wherein the foil cross-section is asymmetric.

3. The fishing trawl of claim 1, wherein the internal conduit is positioned along the chord.

4. The fishing trawl of claim 1, wherein the internal conduit is positioned to one side of the chord.

5. The fishing trawl of claim 1, further comprising a second head line, a second foot line, and second side lines, and wherein the foil segments each further comprise a second internal conduit extending along the span positioned forward of the trailing edge of the foil segment, wherein one of the second head line, second foot line, or second side lines pass through the second internal conduits of the plurality of foil segments.

6. The fishing trawl of claim 5, wherein each foil segment has opposing sides which converge rearwardly from the leading edge to give each foil segment a trapezoidal-like shape with a divergent angle between the sides of adjacent foil segments.

7. The fishing trawl of claim 6, comprising an adjustment mechanism to vary the length of the second head line, second foot line, or one of the second side lines passing through the second internal conduits of the plurality of foil segments.

8. A fishing trawl, comprising:
a net having a mouth opening defined by a head line, a foot line, and side lines;
a foil line having a length and opposed ends; and
a plurality of longitudinally alignable foil segments each having a foil cross-section, a leading edge, a trailing edge, a span, and an internal conduit extending along the span positioned rearward of the leading edge of the foil segment;
wherein the foil line passes through the internal conduits of the plurality of foil segments and is attached at each opposed end to one of the head line, foot line, or side lines at spaced apart locations.

9. The fishing trawl of claim 8, further comprising a second foil line having a length and opposed ends;
wherein the plurality of foil segments further comprise a second internal conduit extending along the span positioned forward of the trailing edge of the foil segment; and
wherein the second foil line passes through the second internal conduits of the plurality of foil segments and is attached at each end to one of the head line, foot line, or side lines at spaced apart locations.

10. The fishing trawl of claim 9, wherein each foil segment has opposing sides which converge rearwardly from the leading edge to give each foil segment a trapezoidal-like shape with a divergent angle between the sides of adjacent foil segments.

11. The fishing trawl of claim 10, comprising an adjustment mechanism to vary the length of the second foil line passing through the second internal conduits of the plurality of foil segments.

12. A fishing trawl, comprising:
a net having a mouth opening defined by a head line, a foot line, and side lines;
a foil line having a length and opposed ends; and
a plurality of longitudinally alignable foil segments each having a foil cross-section, a leading edge, a trailing edge, a span, and an internal conduit extending along the span positioned rearward of the leading edge of the foil segment;
wherein the foil line passes through the internal conduits of the plurality of foil segments and is attached to one of the head line, foot line, or side lines at spaced apart locations by way of a plurality of bridle lines.

13. The fishing trawl of claim 12, further comprising a second foil line having a length and opposed ends;
wherein the plurality of foil segments further comprise a second internal conduit extending along the span positioned forward of the trailing edge of the foil segment; and
wherein the second foil line passes through the second internal conduits of the plurality of foil segments.

14. The fishing trawl of claim 13, wherein the second foil line is secured at each end to prevent egress from the second internal conduits of the plurality of foil segments.

15. The fishing trawl of claim 14, wherein each foil segment has opposing sides which converge rearwardly from the leading edge to give each foil segment a trapezoidal-like shape with a divergent angle between the sides of adjacent foil segments.

16. The fishing trawl of claim 15, comprising an adjustment mechanism to vary the length of the second head line, second foot line, or one of the second side lines passing through the second internal conduits of the plurality of foil segments.

17. A fishing trawl, comprising:
a net having a mouth opening defined by a head line, a foot line, and side lines, and trawl doors spaced apart from and attached to each side line by way of bridle legs;
a tag line attached to the bridle legs and positioned between the side lines and the trawl doors; and
a plurality of longitudinally alignable foil segments each having a foil cross-section, a leading edge, a trailing edge, a span, and an internal conduit extending along the span positioned rearward of the leading edge of the foil segment;
wherein the tag line passes through the internal conduits of the plurality of foil segments.

18. The trawl of claim 17, further comprising a second tag line attached to the bridle legs and positioned between the side lines and the trawl doors;
wherein the plurality of foil segments further comprise a second internal conduit extending along the span positioned forward of the trailing edge of the foil segment; and
wherein the second tag line passes through the second internal conduits of the plurality of foil segments.

19. The fishing trawl of claim 18, wherein each foil segment has opposing sides which converge rearwardly from the leading edge to give each foil segment a trapezoidal-like shape with a divergent angle between the sides of adjacent foil segments.

20. The fishing trawl of claim 19, comprising an adjustment mechanism to vary the length of the second tag line passing through the second internal conduits of the plurality of foil segments.

21. A fishing trawl, comprising:
a net having a mouth opening defined by a head line, a foot line, and side lines;
a foil line having a length and opposed ends, attached to one of the side lines by way of a plurality of bridle legs;
a plurality of longitudinally alignable foil segments each having a foil cross-section, a leading edge, a trailing edge, a span, and an internal conduit extending along the span positioned rearward of the leading edge of the foil segment;
a triangular-like bridle attached to the foil line having an apex, sides, and a base, wherein the apex is defined by a connection point between the bridle and a warp line, the sides are defined by a first bridle line attached between the connection point and one end of the foil line and a second bridle line attached between the connection point and the other end of the foil line, and the base is defined by the foil line; and
one or more intermediate bridle lines attached between the connection point and the foil line;
wherein the foil line passes through the internal conduits of the plurality of foil segments.

22. The fishing trawl of claim 21, wherein the plurality of foil segments are longitudinally aligned, the sides of the bridle are of equal length, and the lengths of the one or more intermediate bridle lines are sized accordingly.

23. The fishing trawl of claim 21, wherein the plurality of foil segments are longitudinally aligned, the sides of the bridle are of unequal length, and the lengths of the one or more intermediate bridle lines are sized accordingly.

24. The fishing trawl of claim 21, wherein the plurality of foil segments are curved, the sides of the bridle are of equal length, and the lengths of the one or more intermediate bridle lines are sized accordingly.

25. The fishing trawl of claim 24, further comprising a second foil line having a length and opposed ends;
wherein the plurality of foil segments further comprise a second internal conduit extending along the span positioned forward of the trailing edge of the foil segment; and
wherein the second foil line passes through the second internal conduits of the plurality of foil segments.

26. The fishing trawl of claim 25, wherein each foil segment has opposing sides which converge rearwardly from the leading edge to give each foil segment a trapezoidal-like shape with a divergent angle between the sides of adjacent foil segments.

27. The fishing trawl of claim 26, comprising an adjustment mechanism to vary the length of the second foil line passing through the second internal conduits of the plurality of foil segments.
